(19) United States
(12) Patent Application Publication
(10) Pub. No.: US 2020/0079320 A1
(43) Pub. Date: Mar. 12, 2020

(54) BIOMETRIC AUTHENTICATION AND VEHICLE FUNCTION CONTROL BASED ON A VEHICLE OPERATION PATTERN

(71) Applicant: MASTERCARD INTERNATIONAL INCORPORATED, Purchase, NY (US)

(72) Inventor: Jason Lacoss-Arnold, Saint Peters, MO (US)

(73) Assignee: MASTERCARD INTERNATIONAL INCORPORATED, Purchase, NY (US)

(21) Appl. No.: 16/124,696

(22) Filed: Sep. 7, 2018

(51) Int. Cl. B60R 25/20; B60R 25/24

(52) U.S. Cl. CPC B60R 25/2081; B60R 25/24

(57) ABSTRACT

Systems, apparatus, and/or methods to provide biometric authentication and/or vehicle function control based on biometric authentication. For example, a vehicle operation pattern may be learned for a vehicle operator that includes a setting value and a drive value. In addition, an authentication of the vehicle operator may be conducted based on the vehicle operation pattern. A vehicle function may then be controlled based on the authentication of the vehicle operator using the vehicle operation pattern.

### BACKGROUND

Authentication of a vehicle operator is important for a variety of security purposes. Accordingly, biometric authentication based on image recognition technology is increasingly being utilized in vehicles. There is, however, considerable room for improvement to provide passive biometric authentication of a vehicle operator and/or to control a vehicle function based on passive biometric authentication technology.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a computing system according to an embodiment;

FIGS. 2A to 2F are block diagrams of an example of a method according to an embodiment;

FIG. 3 is a block diagram of an example of a semiconductor package apparatus according to an embodiment; and

FIG. 4 is a block diagram of an example of another computing system according to an embodiment.

### DESCRIPTION OF EMBODIMENTS

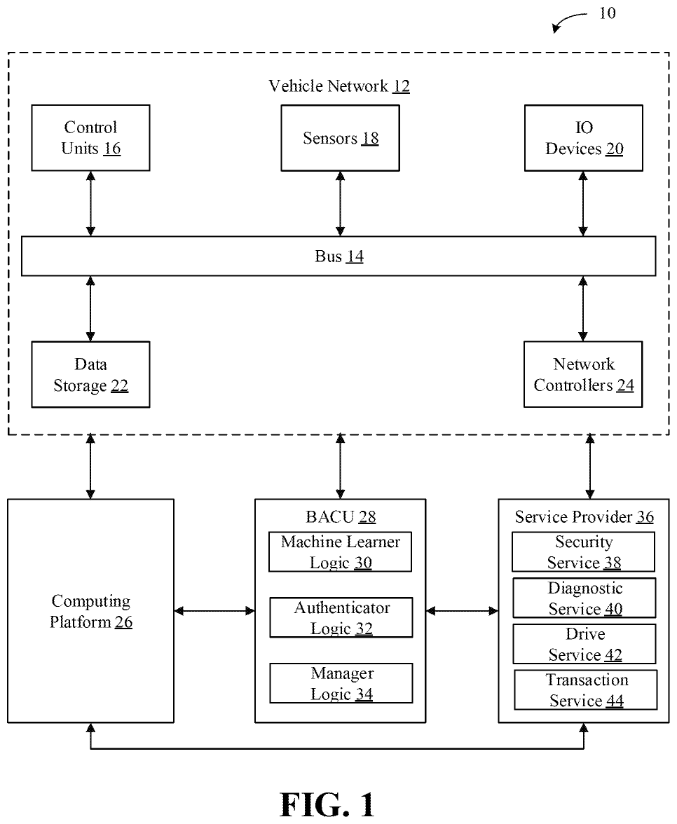

Turning now to FIG. 1, a system 10 is shown to provide passive biometric authentication and/or vehicle function control based on passive biometric authentication according to an embodiment. In the illustrated example, a vehicle network 12 provides a communication framework for a vehicle such as an automobile (e.g., car, bus, etc.), a motorcycle, a truck (e.g., a cargo truck, a fire truck, pickup truck, etc.), and so on. The communication framework may generally include a bus topology such as controller area network (CAN, e.g., ISO 1198, CAN with Flexible Data Rate (CAN-FD), etc.), media oriented systems transport (MOST, e.g., ISO 21806, MOST25, MOST50, MOST150, etc.), local interconnect network (LIN, e.g., ISO 17987, etc.), K-line (e.g., ISO 9141, etc.), FlexRay (e.g., ISO 17458, etc.), etc. As shown in the illustrated example, the vehicle network 12 includes a bus 14 to exchange data among control units 16, sensors 18, input/output (IO) devices 20, data storage 22, and/or network controllers 24.

The control units 16 include any embedded system in vehicle electronics that control an electrical system and/or subsystem in a vehicle. For example, the control units 16 may include an engine control unit, a powertrain control unit, a transmission control unit, a brake control unit, a central timing unit, a general electronic unit, a suspension control unit, and so on. Meanwhile, the sensors 18 may include any device that detects or measures a physical property and records, indicates, and/or otherwise responds to it. Thus, the sensors 18 may include an image sensor, a temperature sensor, a pressure sensor, a geographic location sensor, an acceleration sensor, etc. In one example, the sensors 18 are coupled via an analog-to-digital converter with respective control units 16 that exchange vehicle data over the bus 14 using an onboard diagnostic (OBD) protocol (e.g., SAE J1850 PWM, SAE J1850 VPM, ISO 9141, ISO 14230, ISO 15765, etc.).

Generally, vehicle data that is exchanged over the bus 14 may include a value corresponding to a vehicle function. For example, vehicle data may include a setting value corresponding to a mirror position, a seat position, heating, ventilation and air conditioning (HVAC) use, in-vehicle infotainment (IVI) use, etc. Vehicle data may also include a drive value corresponding to a brake pedal position, break pressure, steering wheel angle, lateral acceleration, yaw rate, vehicle speed, shaft angular velocity, accelerator pedal position, engine speed, driver requested torque, maximum engine torque, throttle position, turn signal usage, etc. In one example, the control units 16 and the IO devices 20 exchange vehicle data to provide a digital representation to a vehicle operator. For example, vehicle data may be rendered to a vehicle operator via an in-dash display, a headrest display, a mirror display, an overhead display, a speaker, and so on. Vehicle data may also be written to the data storage 22 and/or read from the data storage 22 for access. For example, vehicle data may be written to random access memory (RAM), read-only memory (ROM), hard disk drive (HDD), optical disk, solid state disk (SSD), etc. Vehicle data may also be written to volatile memory such as dynamic random access memory (DRAM) or static random access memory (SRAM), non-volatile memory (NVM) such as NAND flash memory, three-dimensional (3D) NAND, SSD, etc.

Vehicle data may be exchanged with a computing platform 26 external to the vehicle network 12 such as a desktop computer, a notebook computer, a tablet computer, a personal digital assistant (PDA), a mobile Internet device (MID), a media player, a smart phone, a wearable device (e.g., smart watch), a server, a point of sale (POS) terminal, etc. In this regard, the network controllers 24 provide functionality for a wide variety of communication purposes such as, for example, cellular telephone (e.g., Wideband Code Division Multiple Access (W-CDMA), Universal Mobile Telecommunications System (UMTS), CDMA2000 (IS-856/IS-2000), etc.), Wireless Fidelity (WiFi, e.g., IEEE 802.11-2007, Wireless Local Area Network (LAN) Medium Access Control (MAC) and Physical Layer (PHY) Specifications, etc.), Light Fidelity (LiFi, e.g., IEEE 802.15-7, Wireless LAN MAC and PHY, etc.), Long Term Evolution (LTE, e.g., 4G, 5G, etc.), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), and other radio frequency (RF) purposes.

The system 10 further includes a biometric authentication and controller unit (BACU) 28 that is communicatively coupled to the vehicle network 12 and the computing platform 26. The illustrated BACU 28 includes machine learner logic 30, authenticator logic 32, and manager logic 34 to authenticate a vehicle operator and/or to control a vehicle function. The logic 30, 32, 34 may include logic instructions stored in a machine- or computer-readable storage medium such as RAM, ROM, programmable ROM (PROM), firmware, flash memory, 3D memory, etc. The logic 30, 32, 34 may also include configurable logic such as programmable logic arrays (PLAs), field programmable gate arrays (FPGAs), complex programmable logic devices (CPLDs), etc. The logic 30, 32, 34 may further include fixed functionality logic such as application specific integrated circuit (ASIC), complementary metal oxide semiconductor (CMOS), transistor-transistor logic (TTL), and/or other fixed functionality technology.

The machine learner logic 30 learns a vehicle operation pattern via, e.g., a machine-learning (ML) model (e.g., backpropagation machine learning, etc.). The machine learner logic 30 may, for example, utilize a setting value and/or a drive value as input to an ML model to learn a vehicle operation pattern. The machine learner logic 30 may also utilize multiple vehicle data samples to determine a statistical significant value such as a statistically significant mean, median, variance, etc. For example, the machine learner logic 30 may determine an average value and/or a variance value to enhance reliability. The machine learner logic 30 may also smooth vehicle data (e.g., a smoothing function) to enhance reliability. The machine learner logic 30 may further utilize a weight to learn a vehicle operation pattern. In one example, the machine learner logic 30 utilizes a greater weight for a seat position value or a mirror position value than for a climate control value. In another example, the machine learner logic 30 utilizes a greater weight for a lateral acceleration value or a break value than for a turn signal value.

Notably, one or more values learned across two or more value categories improves the reliably of authentication and/or function control. For example, the machine learner logic 30 may learn a seat value (e.g., a seat height value, a seat recline angle value, etc.), a mirror value (e.g., a rear-view mirror angle value, a side-view mirror angle value, etc.), a climate control value (e.g., a heated/cooled seat value such as on/off, temperature, zone usage such as front/rear, etc.), an IVI value (e.g., navigation on/off, audio/video on/off, genre, station, volume, language, etc.), etc. The machine learner logic 30 may also learn a vehicle acceleration value (e.g., lateral acceleration, etc.), a vehicle deceleration value (e.g., lateral deceleration, etc.), a vehicle turn signal value (e.g., on/off, average usage, etc.), a vehicle velocity value (e.g., maximum velocity, etc.), a vehicle location value (e.g., current geographic coordinate, merchant address, etc.), a vehicle time-of-use value (e.g., date, time, etc.), etc. Thus, the machine learner logic 30 may learn a vehicle operation pattern that reflects the actual usage characteristics of a vehicle operator at various stages of vehicle operation such as, for example, when the vehicle is parked, before the vehicle is started, while the vehicle is moving, and so on.

A user may define a particular vehicle operation stage by selecting a transition event that indicates the start or end of the particular vehicle operation stage. The machine learner logic 30 may also learn a transition event (e.g., a safety break release, a break pedal engagement, an engine start, a drive gear engagement, etc.). In one example, the machine learner logic 30 learns that a setting value qualifies as a transition event in a first stage when a vehicle operator configures and/or modifies a vehicle function (e.g., door unlock, mirror position change, seat position change, etc.) in a relatively lower power state of the vehicle (e.g., off state, sleep state, etc.). In another example, the machine learner logic 30 learns that a drive value qualifies as a transition event in a second stage when the vehicle operator configures and/or modifies a vehicle function (e.g., breaking, lateral acceleration, etc.) in a relatively higher power state of the vehicle (e.g., normal, etc.). The machine learner logic 30 may determine which events qualify as transition events based on context, a predetermined threshold of event instances, and so on.

Accordingly, the machine learner logic 30 may learn a vehicle operation pattern, a vehicle operation stage, and/or a transition event during a registration process and/or a training process that initially associates a vehicle operation pattern with a vehicle operator. For example, the IO devices 20 and/or the computing platform 26 may be used to allow a vehicle operator to invoke the machine learner logic 30. In addition, other information may be selected and/or learned such as multi-factor authentication requirements, transaction information, subscription information, etc. When a sufficient number of values are evaluated to confidently learn a vehicle operation pattern for a vehicle operator, the values are collected into a vehicle operation pattern and stored in a behavioral biometric profile for the vehicle operator. The vehicle operation pattern may be stored as a set of individual values, may transformed to form an n-bit value (where n=1, 2, . . . ), a hexadecimal value, and so on. For example, a multiplexer and/or a hash function may be used to transform the set of values for storage in the data storage 22.

The machine learner logic 30 also passively and/or continually learns additional vehicle operation patterns for a particular vehicle operator that are stored with a pre-existing vehicle operation pattern in a behavioral biometric profile for that particular vehicle operator. In this regard, a plurality of context-specific vehicle operation patterns (e.g., when load is added to a hitch, when a child car seat is used, during inclement weather, etc.) may be stored in the behavioral biometric profile for that particular vehicle operator. In addition, a new vehicle operation pattern may be stored in a behavioral biometric profile for a new vehicle operator. Thus, a plurality of new vehicle operators may be associated with a plurality of respective context-specific vehicle operation patterns that are stored in respective behavioral biometric profiles.

The authenticator logic 32 conducts an authentication of a vehicle operator based on a vehicle operation pattern. The authenticator logic 32 may conduct a pairwise comparison to determine whether a match condition exists (e.g., within a reasonable amount of error, exact match, etc.) between a vehicle operation pattern and a stored vehicle operation pattern. For example, the authenticator logic 32 may compare a current real-time vehicle operation pattern learned by the machine learning logic 30 with a pre-existing validated vehicle operation pattern stored in the data storage 22 to determine whether a match condition exists. In this regard, the pairwise comparison may be conducted on any basis including on a per-value basis (e.g., using individual values in a set, using an n-bit value, etc., with or without variances), on a subgroup basis (e.g., using grouped values, etc.), etc. The authenticator logic 32 may also communicate with the machine learner logic 30 to implement an ML matching model (e.g., a Bayesian matching algorithm, a fuzzy matching algorithm, etc.) that determines whether a match condition exists. When a match exists, the vehicle operator is authenticated. When a mismatch exists, a security action may be implemented such as issuing a notification to a device (e.g., administrator, law enforcement, service, etc.), tracking, and so on.

The authenticator logic 32 may also utilize a vehicle operation pattern in an encryption process to authenticate a vehicle operator. The authenticator logic 32 may utilize a vehicle operation pattern as a key for a cipher (e.g., a block cipher, etc.) to generate data that authenticates a vehicle operator. In addition, the authenticator logic 32 may utilize a vehicle operation pattern as an integrity check value (ICV) (e.g., error correction code, etc.), a message authentication code (MAC), a message integrity code (MIC), a signature, etc. The authenticator logic 32 may also utilize a vehicle operation pattern to unlock a private key of a public-private key pair that authenticates a vehicle operator in the Fast Identity Online (FIDO) alliance Universal Authentication Framework (UAF) protocol and/or the Universal Second Factor (U2F) protocol.

The authenticator logic 32 may further utilize a vehicle operation pattern in a multi-factor process when single-factor authentication is unsuccessful and/or when authentication requires a plurality of factors. In one example, the IO devices 20 (e.g., a speaker, a microphone, a display, etc.) may be utilized to issue a notification (e.g., an alert, a message, a prompt, etc.) and to receive a response from a vehicle passenger that authorizes the vehicle operator for a vehicle function (e.g., via voice recognition, via image recognition, etc.). In another example, an administrator device (e.g., a passenger smart phone, etc.) may be prompted to issue a notification and/or a response when a second authentication factor (e.g., retinal scan, password, etc.) is needed. For example, the computing platform 26 may be contacted. The authenticator logic 32 may then authenticate a vehicle operator based on a plurality of authentication factors. When multi-factor authentication is unsuccessful, a security action may be implemented.

The manager logic 34 controls a vehicle function based on biometric authentication for an in-vehicle service such as an anti-theft service, an insurance service, a driver assistance service, a payment service, and so on. In one example, the manager logic 34 generates a control message that is processed by the controller units 16 to configure access to a vehicle function (e.g., permit access to an acceleration pedal, deny access to payment system, etc.). In another example, the manager logic 34 generates a control message to configure a value corresponding to a vehicle function (e.g., set a maximum value, set a minimum value, etc.). In this regard, a control message may be encrypted and/or digitally signed to enhance security (e.g., ensure messages are valid, etc.). In a further example, the manager logic 34 allows a service provider 36 to access a component of the vehicle network 12 and/or a component of the BACU 28. In this regard, the service provider 36 may poll for data, utilize an application programming interface (API) to push and/or pull data, and so on.

Generally, the manager logic 34 may deny and/or allow operation of a vehicle function based on an unsuccessful authentication of a vehicle operator. For example, an unsuccessful authentication may cause the manager logic 34 to lock an accelerator pedal, lock a steering wheel, throttle an engine torque, invoke vehicle hazard signals, invoke an image capture device (e.g., to collect user data, tracking data, etc.), etc. Additionally, the manager logic 34 may deny and/or permit operation of a vehicle function based on a successful authentication of a vehicle operator. For example, a successful authentication for an inexperienced driver (e.g., based on age, driving history, current values, etc.) may cause the manager logic 34 to lock a speaker volume range, to lock a vehicle velocity, invoke a vehicle diagnostic, invoke driver assistance (e.g., lane change sensor, route guidance, etc.), invoke a diode (e.g., a seat belt diode, etc.), etc. The manager logic 34 may therefore control a vehicle function based on driving context, input from an administrator (e.g., a vehicle owner, etc.), a pre-configured setting, a service offering, etc.

In the illustrated example, the manager logic 34 communicates with a security service 38 to determine whether an anti-theft service is offered/configured (e.g., for the vehicle, the vehicle operator, etc.). In this regard, the security service 38 may be a third-party security vendor, a data structure (e.g., a database, a library, etc.), etc. Thus, the manager logic 34 may implement an appropriate security activity such as, for example, controlling the sensors 18 to track a location of the vehicle, the network controllers 24 to notify a law enforcement authority, the control units 16 to safely disable the vehicle (e.g., disable drivetrain at a next stop, etc.), the control units 16 to trigger self-driving functionality, etc. Similarly, the manager logic 34 may communicate with a diagnostic service 40 to control, e.g., the sensors 18 to obtain a diagnostic for an insurance service, the network controllers 24 to make a maintenance call for a maintenance service, etc. The manager logic 34 may also communicate with a drive service 42 to control, e.g., the control units 16 to set a vehicle velocity range for a safety service, the network controllers 24 to make a distress call for a road-side assistance service, etc. The manager logic 34 may also communicate with a transaction service 44 to control, e.g., the network controllers 24 for a transaction (e.g., a payment, etc.).

The manager logic 34 may, for example, provide access to a digital wallet used for a transaction between a vehicle and a merchant of a product, a service, and/or information to be purchased (e.g., provides goods and/or services once a transaction is complete). When a vehicle operator uses the IO devices 20 and/or the computing platform 26 to enter information (e.g., credit card number, card validation digits, a new device, etc.) for the digital wallet, the authenticator logic 32 is invoked to authenticate the vehicle operator based on a vehicle operation pattern. If authentication is successful, the digital wallet adds the information into a digital wallet profile for the vehicle operator. If authentication is unsuccessful, a security action may be implemented such as preventing access to the digital wallet, multi-factor authentication, tracking, and so on. Thus, the digital wallet may be directly managed based on a localized in-vehicle authentication via a subsystem-to-subsystem communication without requiring a third party.

The manager logic 34 may also allow a vehicle to communicate with a merchant system and/or with a digital wallet via a third party in accordance with a secure protocol (e.g., EMV 3-D secure protocol (3DS) and core functions specification v2.1.0, UAF, U2F, etc.). In one example, an access control server (ACS) in an issuer domain of a 3DS framework may authenticate a consumer for a transaction via, e.g., an adaptive authentication protocol (e.g., RSA® adaptive authentication, etc.). The authenticator logic 32 may then be invoked for adaptive authentication by the ACS (e.g., in high-risk scenarios, etc.) based on a vehicle operation pattern. When utilized together with the UAF protocol and/or the U2F protocol, successful authentication by the authenticator logic 32 unlocks a private key of a public-private key pair used to authenticate a vehicle operator in a 3DS challenge flow. In this regard, the manager logic 34 may include a 3DS client and the transaction service 44 may include an ACS in a 3DS framework.

In another example, a passenger seated next to a vehicle operator in a driver seat may wish to add a new card (e.g., ending in ‘1234’) to his or her own computing platform identifiable by a name, an internet protocol (IP) address, a mobile identification number (MIN), etc. In a 3DS flow, an ACS queries the passenger via, e.g., a speaker of their computing platform to identify which devices are authorized to provide authentication in the 3DS framework. The passenger can assert that the vehicle is authorized via, e.g., a verbal response using a microphone of his or her own computing platform. The authenticator logic 32 authenticates the vehicle operator based on a vehicle operator pattern and the new payment card is added to the computing platform of the passenger when authentication is successful. For example, the IO devices 20 may be used to issue a prompt (e.g., a verbal prompt via a vehicle speaker that asks “do you want to add new card ending in ‘1234’ to the device named ‘Phone_Name’”) and to receive a response (e.g., a verbal response via a vehicle microphone that affirms “yes”). When utilized with the UAF protocol and/or the U2F protocol, successful authentication by the authenticator logic 32 unlocks a same private key of a same public-private key pair that may repeatedly be used to authenticate the vehicle operator in a 3DS challenge flow.

The manager logic 34 may also determine a merchant category and/or an operator category for an in-vehicle service. For example, the manager logic 34 may determine that a merchant provides a parking space (e.g., a meter, a parking garage, a parking lot, etc.). The manager logic 34 may, for example, utilize the network controllers 24 to determine a merchant category via a geolocation database (e.g., through an API, etc.), via an NFC communication (e.g., with a meter, a POS terminal, etc.), and so on. Thus, access to an in-vehicle payment function may be allowed when the vehicle operator that parked the vehicle in the parking space is authenticated. In one example, the manager logic 34 is authorized to conduct an in-vehicle payment up to a certain amount automatically without notifying the vehicle operator and/or an authorized device (e.g., a smart phone of a vehicle owner, a smart phone of a financial account owner, a smart phone of the vehicle operator, etc.). In addition, the vehicle operator and/or an authorized device may be contacted to authorize a transaction (e.g., adding more parking time, etc.). Thus, a transaction may be conducted while a vehicle is in a low power state and/or without requiring the presence of any vehicle operator.

The manager logic 34 may also determine that a vehicle operator is not a vehicle owner and/or a financial account owner for in-vehicle payments but is authorized for a transaction. For example, the manager logic 34 may utilize the network controllers 24 to identify data (e.g., social network data, user-input data, a vehicle operation pattern, etc.) and determine that a vehicle operator is a family member, a friend, etc. The manager logic 34 may then determine how to conduct a transaction based on a context of the transaction including a merchant category, privileges, restrictions (e.g., vehicle operator temporal restrictions, geographic restrictions, etc.), etc. The manager logic 34 may, for example, determine a driver has changed to a child of an owner of the vehicle based on a vehicle operation pattern and automatically allows access to a digital wallet to pay for a parking space, a toll, a fast-food charge, a car wash, a speeding ticket, etc. Restrictions may also be imposed based on a merchant category and/or an operator category. For example, an amount paid for tolls may be capped based on a restriction (e.g., location, temporal, etc.) for a child of a vehicle owner and/or a financial account owner whereas full privileges apply to a spouse.

While examples have provided various components of the system 10 for illustration purposes, it should be understood that one or more components of the system 10 may reside in the same and/or different physical and/or virtual locations, may be combined, omitted, bypassed, re-arranged, and/or be utilized in any order. For example, a component of the BACU 28 and/or the service provider 36 may reside in the same and/or different physical and/or virtual location as a component of the vehicle network 12 and/or the computing platform 26. Moreover, any or all components of the system 10 may be automatically implemented (e.g., without human intervention, etc.).

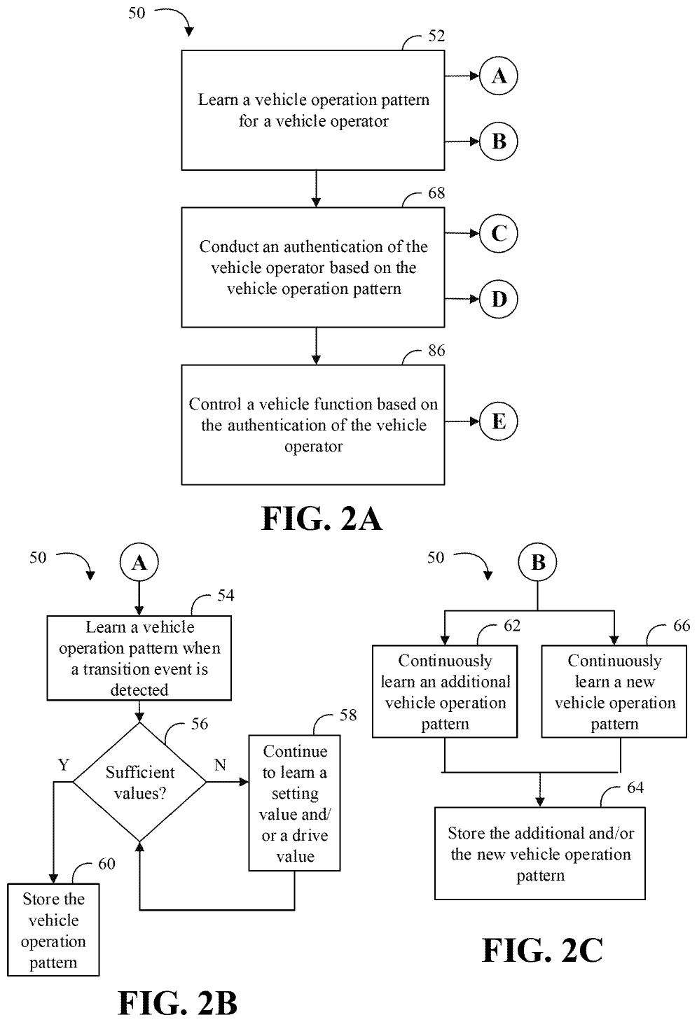

Turning now to FIGS. 2A to 2F, a method 50 is to shown to provide passive biometric authentication and/or vehicle function control based on passive biometric authentication according to an embodiment. The method 50 may be implemented in a system such as, for example, the system 10 (FIG. 1), already discussed. More particularly, the method 50 may be implemented as a module or related component in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof. For example, computer program code to carry out operations shown in the method 50 may be written in any combination of one or more programming languages, including an object oriented programming language such as JAVA, SMALLTALK, C++ or the like and traditional procedural programming languages, such as the “C” programming language or similar programming languages.

Embodiments or portions of the method 50 may be implemented in firmware, applications (e.g., through an API, an extension, a plug-in, etc.), or driver software running on an OS. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

Block 52 learns a vehicle operation pattern for a vehicle operator. The vehicle operator may be, for example, an individual in a driver seat of a vehicle, a driver of a vehicle, a person that last drove a vehicle, etc. The vehicle operation pattern may include a setting value and/or a drive value for a vehicle operator. The setting value may include a mirror value, a seat value, a climate control value, an in-vehicle infotainment value, etc. The drive value may include a vehicle acceleration value, a vehicle deceleration value, a vehicle turn signal value, a vehicle velocity value, a vehicle location value, or a vehicle time-of-use value, etc. Block 52 may implement an ML model (e.g., a backpropagation ML model, etc.) to learn the vehicle operation pattern for the vehicle operator.

Block 54 learns a vehicle operation pattern when a transition event is detected. Block 54 may learn a vehicle operation pattern when a user-selected transition event is detected. Block 54 may also learn a vehicle operation pattern when a machine-learned transition event is detected. A determination is made at block 56 whether a sufficient number of values are learned to confidently associate a vehicle operation pattern with a vehicle operator. For example, a seat position value and/or a mirror position value may be sufficient to associate a vehicle operation pattern with a vehicle operator when the vehicle operator is unusually large or small, when the values have large weights, etc. Similarly, a lateral acceleration value and/or a break value may be sufficient to associate a vehicle operation pattern with a vehicle operation when the vehicle operation is unusual and/or uncommon relative to the general population, when enough samples are taken, etc.

If a sufficient number of values are not learned at block 56, then block 58 continues to learn a setting value and/or a drive value until a sufficient number of values are learned. Notably, one or more values learned across two or more value categories improves the reliably of authentication and/or the reliability of vehicle function control since a vehicle operation pattern might ultimately be provided that reflects the actual usage characteristics of a vehicle operator at various stages of vehicle operation. Thus, combinations of values (e.g., a combination of a setting value and a drive value) may enhance learning. Block 60 stores the vehicle operation pattern, e.g., in a behavioral biometric profile for the vehicle operator when a sufficient number of values are learned.

Block 62 continuously learns an additional vehicle operation pattern for a vehicle operator. For example, a vehicle operator may operate a vehicle in accordance with a pre-existing validated vehicle operation pattern that is stored in a biometric profile for the vehicle operator. A change in a driving preference and/or habit of the vehicle operator may occur later in time. In one example, the vehicle operator may add a load to a hitch that changes a lateral acceleration value, may gain weight that changes a seat position value, and so on. In response, block 62 may prompt the vehicle operator to verify their identity (e.g., via a verbal prompt, via a passcode, etc.) or automatically identifies the vehicle operator (e.g., via image recognition technology, via the presence of a security factor such as a key fob and/or a computing platform, etc.). Block 62 may also respond to and/or initiate a training process for the vehicle operator.

Block 64 stores the additional vehicle operation pattern, e.g., in a behavioral biometric profile together with a pre-existing vehicle operation pattern for that vehicle operator so that a plurality of context-specific vehicle operation patterns are provided for that vehicle operator. Block 66 continuously learns a new vehicle operation pattern for a new vehicle operator. Block 66 may detect an unknown vehicle operation pattern and prompt a vehicle passenger to verify the identity of the vehicle operator (e.g., via a verbal prompt, via a passcode, etc.) or automatically determines the presence and/or identity of a new unknown vehicle operator (e.g., via image recognition technology, etc.). Block 66 may also respond to and/or initiate a training process for the new vehicle operator. Block 64 then stores the new vehicle operation pattern, e.g., in a behavioral biometric profile for the new vehicle operator. In this regard, a security action may be implemented when the new vehicle operation is not authorized to use a function of the vehicle.

Block 68 conducts an authentication of the vehicle operator based on a vehicle operation pattern. Block 68 may, for example, utilize a vehicle operation pattern in a comparison process to authenticate the vehicle operator, in an encryption process to authenticate the vehicle operator, in a multi-factor process to authenticate the vehicle operator, etc. Block 70 identifies a current (e.g., real-time, near real-time, etc.) vehicle operation pattern and/or a stored (e.g., previously validated, etc.) vehicle operation pattern. Block 72 determines whether a match condition exists between the current vehicle operation pattern and the stored vehicle operation pattern (e.g., comparison on a per-value basis, via an ML matching model, etc.). If so, block 74 indicates that the vehicle operator is authenticated via, e.g., a notification, a message, etc. If not, block 76 indicates that the vehicle operator is not authenticated. Block 76 may also implement a security action such as notifying an administrator device, notifying a law enforcement authority, tracking the vehicle and/or the vehicle operator (e.g., without knowledge of the vehicle operator), safely disabling the vehicle, triggering self-driving functionality, etc.

Block 78 utilizes a vehicle operation pattern as a key for a cipher. For example, block 78 may utilize a vehicle operation pattern as a key for a block cipher in any mode of operation. Block 80 may compare data that is generated by an encryption cipher with stored data to determine whether the user is successfully authenticated. If so, block 74 indicates that the vehicle operator is authenticated. If not, block 76 indicates that the vehicle operator is not authenticated and may implement a security action. Additionally, block 82 utilizes a vehicle operation pattern as error check value. For example, block 82 may utilize a vehicle operation pattern as an ICV that can be compared to a stored value at block 80. Moreover, block 84 utilizes a vehicle operation pattern to unlock a key (e.g., of a public-private key pair). Block 80 may, for example, confirm whether a private key is successfully unlocked and block 74 may indicate that a vehicle operator is authenticated for a secure protocol (e.g., UAF, etc.). In this regard, variances in vehicle operation patterns may be allowed and/or vehicle operation patterns may be transformed to normalized values to enhance reliability at blocks 78, 82, 84.

Block 86 controls a vehicle function based on an authentication of a vehicle operator. Block 86 may, for example, configure access to a vehicle function for an in-vehicle service based on an authentication of the vehicle operator. Block 86 may also configure a value corresponding to a vehicle function for an in-vehicle service based on an authentication of the vehicle operator. The in-vehicle service may include an anti-theft service, an insurance service, a driver assistance service, a payment service, etc. Accordingly, block 86 may generate and/or route a control message (e.g., an enable signal, a disable signal, etc.) that configures access to a vehicle function (e.g., permit access to an acceleration pedal, deny access to payment system, etc.), that configures a value corresponding to a vehicle function (e.g., set a maximum value, etc.), and so on. In one example, block 86 may encrypt and/or digitally sign a control message. In addition, block 86 may be involved in establishing a secure tunnel between a security authority and a component of a vehicle network (e.g., exchange keys, allocate ports, etc.).

Block 88 determines a merchant category (sometimes referred to as a merchant category code or MCC) for an in-vehicle service. For example, block 88 may determine whether a merchant is a toll, a restaurant, a parking space, a car wash, and so on. In addition, block 90 determines an operator category for an in-vehicle service. For example, block 90 may determine whether a vehicle operator is a family member of a vehicle owner and/or a financial account owner for in-vehicle payments, a friend of a vehicle owner and/or a financial account owner, etc. Blocks 88, 90 may make respective determinations via a database (e.g., geolocation database, etc.), communication functionality (e.g., NFC, etc.), vehicle operator input, and so on. A determination is made at block 92 whether a restriction is applicable to the merchant, the vehicle, and/or the vehicle operator. In one example, an amount to be paid for a car wash may be limited to a threshold amount. In another example, an amount to be paid for a toll may be limited to a threshold amount on a per-day basis, on a per-trip basis, etc. In a further example, gas to be purchased at a gas station may be limited to a particular octane level for a particular merchant. Moreover, a restriction may be configured for particular types of vehicle operators such as children, spouses, friends, and so on. If a restriction is applicable, block 94 controls a vehicle function based on any restrictions. If a restriction is not applicable, block 96 controls a vehicle function based on full privilege.

Accordingly, a vehicle operator may approach a gas station in a vehicle. Block 88 determines that a merchant category is a gas station and block 90 determines that the vehicle operator is a vehicle owner and/or an authorized user of a digital wallet that is co-located with the vehicle (e.g., embedded in-vehicle wallet), co-located with a computing device of the vehicle operator (e.g., a smart phone, etc.), etc. In addition, block 92 determines no restrictions apply since the vehicle operator has set unlimited privileges for their digital wallet. Notably, the determinations at blocks 88, 90, 92 may be made at any time (e.g., while the vehicle is turned off and the vehicle operator has exited the vehicle to pump gas, as the vehicle awaits for an open pump, as the vehicle approaches a gas station, etc.). When an embedded digital wallet that is co-located with the vehicle is used for the financial transaction, there is sufficient battery power from the vehicle for the transaction even when the ignition is off. Thus, block 96 allows the digital wallet to automatically complete a purchase (e.g., gas, car wash, food, etc.). The vehicle operator may therefore travel in the vehicle through a toll road, onto a street for gas, through a drive-through restaurant for food, and arrive at a parking space while financial transactions are being completed automatically based on passive biometric authentication using a vehicle operation pattern for the vehicle operator.

While independent blocks and/or a particular order has been shown for illustration purposes, it should be understood that one or more of the blocks of the method 50 may be combined, omitted, bypassed, re-arranged, and/or flow in any order. Moreover, any or all blocks of the method 50 may be automatically implemented (e.g., without human intervention, etc.).

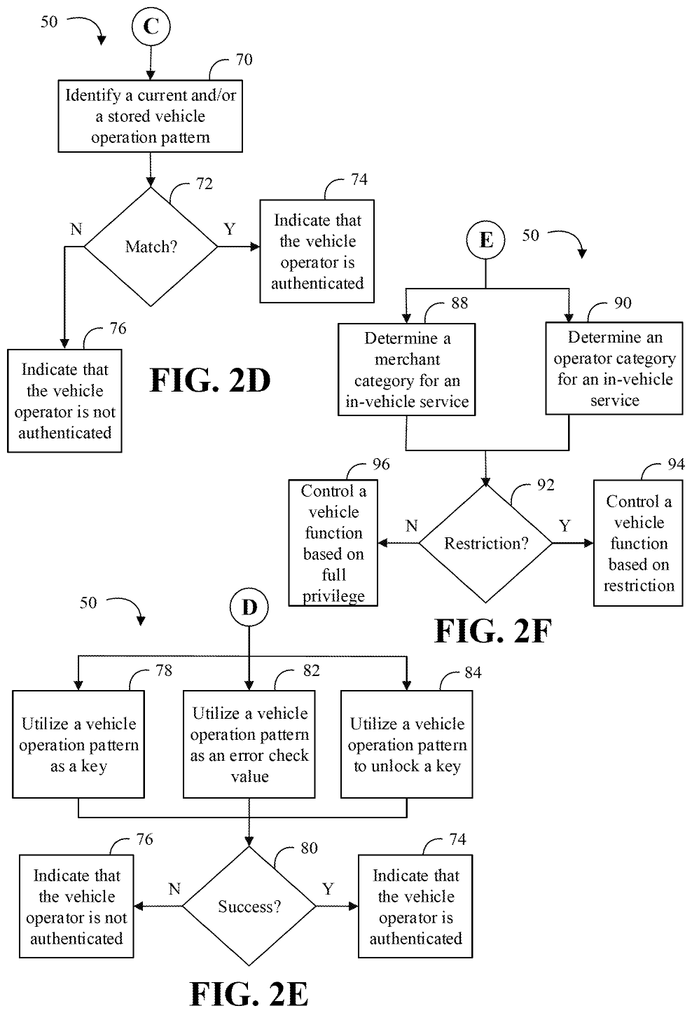

Turning now to FIG. 3, an embodiment of a semiconductor package apparatus 310 includes one or more substrates 312 (e.g., silicon, sapphire, gallium arsenide, etc.) and BACU logic 314 (e.g., transistor array and other integrated circuit/IC components, etc.) coupled to the substrates 312. The apparatus 310 may be implemented in one or more components of the system 10 (FIG. 1), already discussed. Additionally, the BACU logic 314 may be the same as one or more of the logic 30, 32, 34 (FIG. 1), already discussed. Moreover, the apparatus 310 may implement one or more of the aspects of the method 50 (FIGS. 2A to 2F), already discussed. Thus, the BACU logic 314 provides passive biometric authentication and/or vehicle function control based on passive biometric authentication.

Embodiments of the BACU logic 314, and other components of the apparatus 310, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. In one example, the BACU logic 314 may include transistor channel regions positioned (e.g., embedded) within the substrates 312. Thus, the interface between the BACU logic 314 and the substrates 312 may not be an abrupt junction. The BACU logic 314 may also be considered to include an epitaxial layer that is grown on an initial wafer of the substrates 312.

Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C # or the like and conventional procedural programming languages, such as the “C” programming language or similar programming languages.

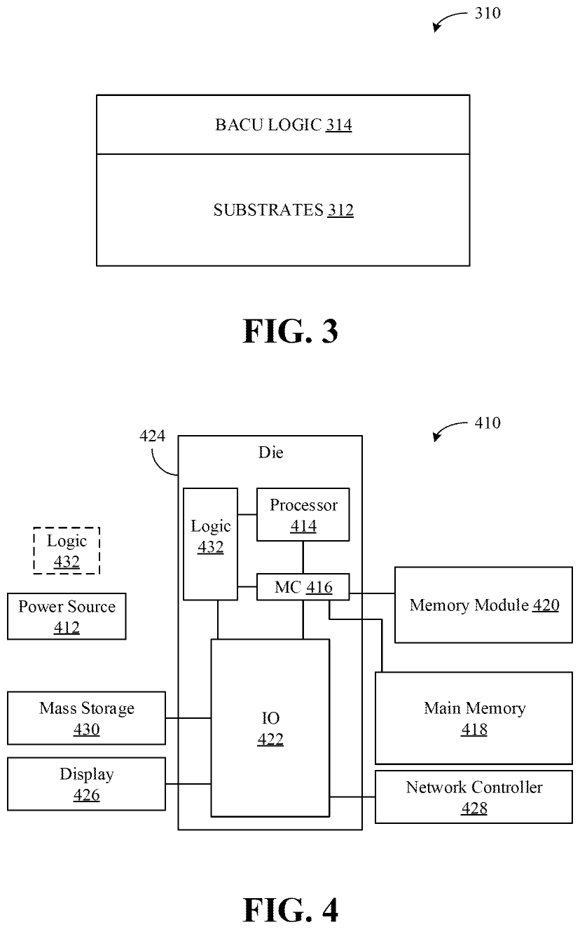

Turning now to FIG. 4, an example of an electronic processing system 410 is shown to provide passive biometric authentication and/or vehicle function control based on passive biometric authentication according to an embodiment. The system 410 may generally be part of an electronic device/platform having computing functionality (e.g., datacenter, cloud server, personal digital assistant/PDA, notebook computer, tablet computer, laptop, etc.), imaging functionality (e.g., camera, projector, etc.), media playing functionality (e.g., smart television/TV, gaming platform, smart phone, etc.), wearable functionality (e.g., watch, eyewear, headwear, footwear, etc.), vehicular functionality (e.g., car, truck, motorcycle, etc.), communication functionality, and so on.

The system 410 includes a power source 412. The system 410 also includes a processor 414, such as a micro-processor, an embedded processor, a digital signal processor (DSP), a central processing unit (CPU), a graphical processing unit (GPU), a visual processing unit (VPU), a network processor, hardware that executes code to implement one or more aspects of the technology described herein, etc. For example, the processor 414 may include one or more cores to execute operations (e.g., a single-threaded core, a multithreaded core including more than one hardware thread context (or “logical processor”) per core, etc.). The processor 414 may also be coupled to internal storage such as a cache (e.g., instruction cache, data cache, single level cache, multilevel cache, shared cache, strictly inclusive cache, exclusive cache, etc.), etc.

In the illustrated example, the processor 414 is communicatively coupled to a memory controller 416 that controls access to a memory device. The illustrated memory controller 416 is communicatively coupled to main memory 418. The main memory 418 may include, for example, RAM, ROM, PROM, EPROM, EEPROM, etc., PCM, 3D memory, etc. The memory controller 416 is also communicatively coupled to memory module 420. The memory module 420 may include, for example, DRAM configured as one or more memory modules such as dual inline memory modules (DIMMs), small outline DIMMs (SODIMMs), etc. Thus, the memory controller 416 may control direct memory access (DMA), remote DMA (RDMA), and so on.

The system 410 also includes an input output (10) module 422 implemented together with the processor 414 and the memory controller 416 on a semiconductor die 424 as an SoC, wherein the IO module 422 functions as a host device and may communicate with, for example, a display 426 (e.g., touch screen, liquid crystal display/LCD, light emitting diode/LED display), a network controller 428 (e.g., Ethernet controller, etc.), and mass storage 430 (e.g., hard disk drive/HDD, optical disk, flash memory, etc.). The system 410 further includes logic 432 communicatively coupled to the processor 414, the memory controller 416, and the IO module 422 on the semiconductor die 424. The logic 432 may also be implemented elsewhere in the system 410 and/or outside of the system 410. The logic 432 may be the same as one or more of the logic 30, 32, 34 (FIG. 1) and/or the BACU logic 314 (FIG. 3), already discussed. Moreover, the logic 432 may implement one or more of the aspects of the method 50 (FIGS. 2A to 2F), discussed above. Thus, the logic 432 provides passive biometric authentication and/or vehicle function control based on passive biometric authentication.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so on” or “etc.” may mean any combination of the listed terms as well with other terms.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A computing system comprising:
a processor; and
logic communicatively coupled to the processor to:
machine learn a vehicle operation pattern for a vehicle operator through an assignment of different weights to a setting value and a drive value, wherein the vehicle operation pattern is to include the setting value and the drive value; and
conduct an authentication of the vehicle operator based on the vehicle operation pattern.

2. The system of claim 1, wherein:
the setting value is to include one or more of a mirror value, a seat value, a climate control value, or an in-vehicle infotainment value, and wherein the drive value is to include one or more of a vehicle acceleration value, a vehicle deceleration value, a vehicle turn signal value, a vehicle velocity value, a vehicle location value, or a vehicle time-of-use value; and
the logic is further to machine learn the vehicle operation pattern through one or more of:
an assignment of a first weight for the seat value or the mirror value, and an assignment of a second weight to the climate control value, wherein the first weight is greater than the second weight; or
an assignment of a third weight for a lateral acceleration value or the vehicle deceleration value, and an assignment of a fourth weight for a turn signal value, wherein the third weight is greater than the fourth weight.

3. The system of claim 1, wherein the logic is further to:
learn an additional vehicle operation pattern for the vehicle operator to be stored with the vehicle operation pattern in a behavioral biometric profile for the vehicle operator; and
learn a new vehicle operation pattern for a new vehicle operator to be stored in a behavioral biometric profile for the new vehicle operator.

4. The system of claim 1, wherein the logic is further to utilize the vehicle operation pattern in a comparison process, an encryption process, and a multi-factor process to authenticate the vehicle operator.

5. The system of claim 1, wherein the logic is further to utilize the vehicle operation pattern to unlock a private key that is to be used to authenticate the vehicle operator.

6. The system of claim 1, wherein the logic is further to control a vehicle function based on the authentication of the vehicle operator.

7. The system of claim 6, wherein the logic is further to determine a merchant category and an operator category to control the vehicle function.

8. At least one non-transitory computer readable storage medium comprising a set of instructions, which when executed by a processor, cause the processor to:
machine learn a vehicle operation pattern for a vehicle operator through an assignment of different weights to a setting value and a drive value, wherein the vehicle operation pattern is to include the setting value and the drive value; and
conduct an authentication of the vehicle operator based on the vehicle operation pattern.

9. The at least one non-transitory computer readable storage medium of claim 8, wherein:
the setting value is to include one or more of a mirror value, a seat value, a climate control value, or an in-vehicle infotainment value, and wherein the drive value is to include one or more of a vehicle acceleration value, a vehicle deceleration value, a vehicle turn signal value, a vehicle velocity value, a vehicle location value, or a vehicle time-of-use value; and
the instructions, when executed, cause the processor to learn the vehicle operation pattern through one or more of:
an assignment of a first weight for the seat value or the mirror value, and an assignment of a second weight to the climate control value, wherein the first weight is greater than the second weight; or
an assignment of a third weight for a lateral acceleration value or the vehicle deceleration value, and an assignment of a fourth weight for a turn signal value, wherein the third weight is greater than the fourth weight.

10. The at least one non-transitory computer readable storage medium of claim 8, wherein the instructions, when executed, cause the processor to:
learn an additional vehicle operation pattern for the vehicle operator to be stored with the vehicle operation pattern in a behavioral biometric profile for the vehicle operator; and
learn a new vehicle operation pattern for a new vehicle operator to be stored in a behavioral biometric profile for the new vehicle operator.

11. The at least one non-transitory computer readable storage medium of claim 8, wherein the instructions, when executed, cause the processor to utilize the vehicle operation pattern in a comparison process, an encryption process, and a multi-factor process to authenticate the vehicle operator.

12. The at least one non-transitory computer readable storage medium of claim 8, wherein the instructions, when executed, cause the processor to utilize the vehicle operation pattern to unlock a private key that is to be used to authenticate the vehicle operator.

13. The at least one non-transitory computer readable storage medium of claim 8, wherein the instructions, when executed, cause the processor to control a vehicle function based on the authentication of the vehicle operator.

14. The at least one non-transitory computer readable storage medium of claim 13, wherein the instructions, when executed, cause the processor to determine a merchant category and an operator category to control the vehicle function.

15. A method comprising:
machine learning a vehicle operation pattern for a vehicle operator through an assignment of different weights to a setting value and a drive value, wherein the vehicle operation pattern includes the setting value and the drive value; and
conducting an authentication of the vehicle operator based on the vehicle operation pattern.

16. The method of claim 15, further including:
learning an additional vehicle operation pattern for the vehicle operator to be stored with the vehicle operation pattern in a behavioral biometric profile for the vehicle operator; and
learning a new vehicle operation pattern for a new vehicle operator to be stored in a behavioral biometric profile for the new vehicle operator.

17. The method of claim 15, further including utilizing the vehicle operation pattern in a comparison process, an encryption process, and a multi-factor process to authenticate the vehicle operator.

18. The method of claim 15, further including utilizing the vehicle operation pattern to unlock a private key that is to be used to authenticate the vehicle operator.

19. The method of claim 15, further including controlling a vehicle function based on the authentication of the vehicle operator.

20. The method of claim 19, further including determining a merchant category and an operator category to control the vehicle function.
